(19) United States
(12) Patent Application Publication
(10) Pub. No.: US 2011/0302737 A1
(43) Pub. Date: Dec. 15, 2011

(54) WASHING DEVICE

(75) Inventor: Stacey Bingaman, Gurnee, IL (US)

(73) Assignee: Paris Presents Incorporated, Gurnee, IL (US)

(21) Appl. No.: 13/109,283

(22) Filed: May 17, 2011

Related U.S. Application Data
(60) Provisional application No. 61/353,455, filed on Jun. 10, 2010.

(51) Int. Cl. A47K 7/02; B23P 17/04

(52) U.S. Cl. 15/209.1; 29/428

(57) ABSTRACT

The present invention provides a washing device (200). The washing device (200) includes a plurality of washing members (220a-220c). Further, the washing device (200) includes a coupling element (221a, 221b) coupling two or more of the plurality of washing members (220a-220c) such that the plurality of washing members (220a-220c) are movable relative to one another in one or more directions. The washing device (200) also includes a first attachment member (230a) coupled to one or more of the washing members (220a-220c) or the coupling element (221a, 221b).

### RELATED APPLICATIONS

This application claims the benefit of U.S. provisional application No. 61/353,455 filed on Jun. 10, 2010 entitled “Washing Device” which is hereby incorporated by reference into this application.

### TECHNICAL FIELD

The present invention relates to, washing devices, and more particularly, to a washing device including one or more washing members and one or more attachment members.

### BACKGROUND OF THE INVENTION

Washing and cleaning devices are generally known and are sold in a wide variety of configurations. One particular type of a washing device comprises a body-washing device designed to aid in the cleaning of a body of a person or other animal or a portion of a body of a person or animal. Body-washing devices typically comprise one or more washing members such as a sponge, a loofah, exfoliating fabric, such as netting, cloths, etc. In some devices, the washing members are also configured to hold or retain an amount of a cleaning agent such as soap, body wash, lotion, etc. A user can manipulate the washing device to contact the one or more washing members with the user's body or the body of another person or animal to wash the contacted surface.

Some washing devices also include handles or grips that extend from the washing members to aid a user in washing difficult to reach areas such as the back. The handles come in a variety of configurations including ropes, cords, plastic, etc. One problem associated with washing devices is storage between uses. The washing device is typically stored on the floor of a shower or held in a rack or support within the shower. These are not ideal solutions; however, because the washing device may not properly dry resulting in mold and bacteria, which often shortens the useable life span of the washing device. Another problem associated with typical washing devices is that the washing device has a fixed size and configuration. While a relatively long and slim washing device may be desired to wash a user' s back, a more compact washing device may be desired to wash other areas. Therefore, a user typically must compromise between the two and purchase a washing device that is only ideal for limited applications or purchase multiple washing devices with different configurations.

FIG. 1 shows a prior art washing device 10. The prior art washing device 10 includes a plurality of washing members 20a-20c. The washing members 20a-20c may be configured to wash or clean a portion of a human or animal body. The washing members 20a-20c may be formed from a sponge, a loofah, exfoliating fabric, such as netting, cloths, etc. The washing members 20a-20c may be configured to retain a cleaning agent such as soap or lotion, which can then be applied to a user during use. The washing members 20a-20c may be configured to clean, exfoliate, and/or scrub a user' s skin The prior art washing device 10 includes one or more coupling elements 21a, 21b. The coupling elements 21a, 21b are provided to connect the two or more washing members 20a-20c together. As shown, the first coupling element 21a connects the first and second washing members 20a, 20b together, while the second coupling element 21b connects the second and third washing members 20b, 20c together, thereby forming a single row of washing members 20a-20c. Further shown in FIG. 1 are handles 22. The handles 22 are connected to end washing members 20a, 20c. The handles 22 provide a convenient location for a user to hold onto the washing device 10. The handles 22 may comprise cord, rope, string, etc. Alternatively, the handles 22 may comprise a relatively rigid structure, such as plastic.

In use, a user can grasp one or both of the handles 22 and manipulate the washing device 10 in order to clean a portion of a body. The washing members 20a-20c, the coupling elements 21a, 21b, or both may stretch or otherwise deform in order to extend the overall length, L, of the washing device.

While the prior art washing device 10 provides some advantage over bathing without the aid of the washing device 10, the prior art washing device 10 has inherent drawbacks. As explained above, the prior art washing device 10 includes three washing members 20a-20c, which are connected to form a single row using the coupling elements 21a, 21b. As a result, the washing device 10 comprises a relatively long and slim design. Therefore, while the prior art washing device 10 may be useful for washing a user's back, it is generally inconvenient and cumbersome for washing other areas because the majority of the washing device 10 will hang loose while the user is grasping a portion of the washing device 10. This can create a hazard for users that may become entangled within the washing device 10. Therefore, a user may require a separate washing device including a single washing member for bathing areas that are not as difficult to reach. Further, between uses, a user is faced with a challenge of how to store the washing device 10. A user may be required to place the washing device 10 on a shower floor or in a rack, for example. Neither of which provide a good storage solution as the washing device 10 may not properly dry between uses.

The present invention overcomes these and other problems and an advance in the art is achieved. The present invention provides a washing device comprising an elongated structure including one or more washing members. The washing device also includes one or more attachment elements attached at one or both ends of the washing device.

### SUMMARY OF THE INVENTION

A washing device is provided according to an embodiment of the invention. The washing device includes a plurality of washing members and a coupling element. According to an embodiment of the invention, the coupling element is provided to couple two or more of the plurality of washing members such that the plurality of washing members are movable relative to one another in one or more directions. According to an embodiment of the invention, the washing device also includes a first attachment member coupled to one or more of the washing members or the coupling element.

A method of forming a washing device including a plurality of washing members is provided according to an embodiment of the invention. The method comprises a step of coupling two or more washing members of the plurality of washing members using a connecting element such that the two or more washing members are movable relative to one another in one or more directions. According to an embodiment of the invention, the method also comprises a step of coupling a first attachment member to one or both of a washing member of the plurality of washing members and a connecting element.

### BRIEF DESCRIPTION OF THE DRAWINGS

FIG. 1 shows a prior art washing device

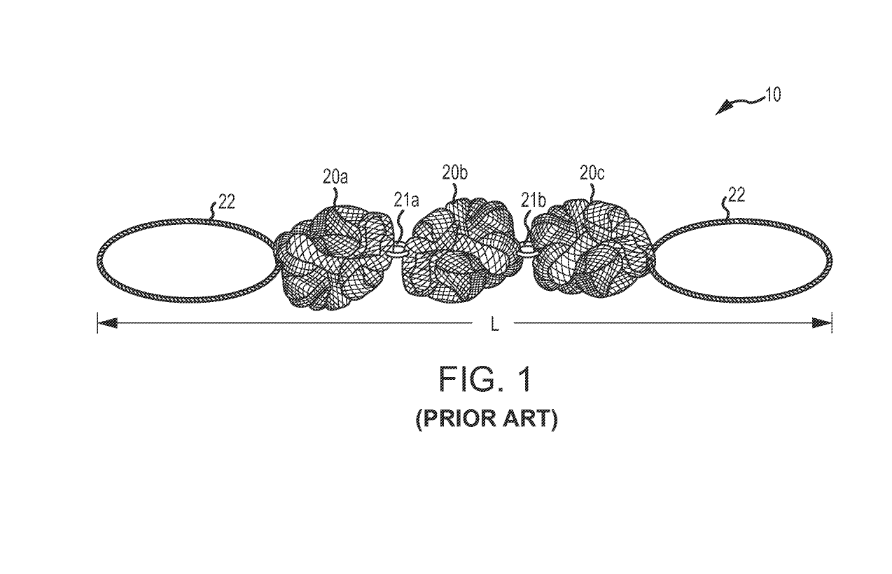

FIG. 2 shows a washing device according to an embodiment of the invention.

FIG. 3 shows the washing device according to another embodiment of the invention.

FIG. 4 shows the washing device according to another embodiment of the invention.

### DETAILED DESCRIPTION OF THE INVENTION

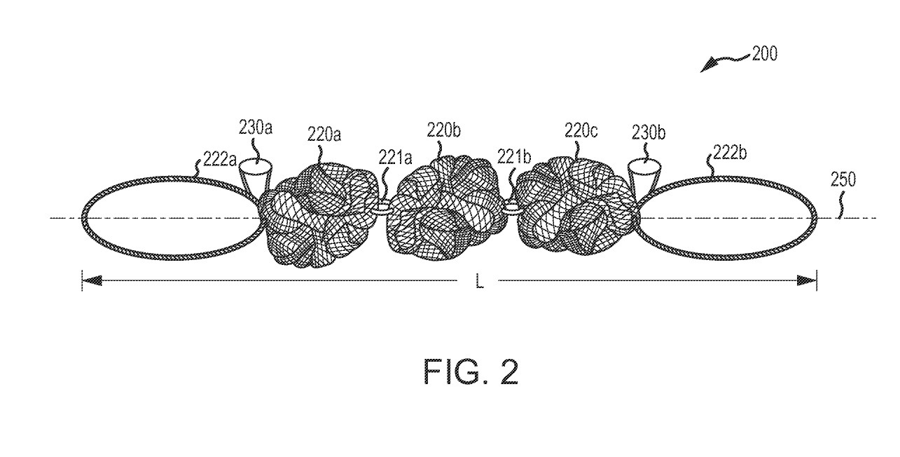

FIGS. 2-4 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 2 shows a washing device 200 according to an embodiment of the invention. The washing device 200 may be provided to wash a body of a human or other animal as is generally known for purposes of health and hygiene. According to another embodiment of the invention, the washing device 200 may be provided to wash or clean a different surface. The washing device 200 according to the embodiment shown in FIG. 2 includes a plurality of washing members 220a-220c. The plurality of washing members 220a-220c may be formed from a sponge, a loofah, exfoliating fabric, such as netting, cloths, mesh, etc. The particular material used for forming the washing members 220a-220c is not important for purposes of the present invention and should in no way limit the scope of the present invention. Further, the particular material used for the washing members 220a-220c may vary depending on a desired roughness and/or intended use. According to some embodiments of the invention, the washing members 220a-220c may be formed from different materials having differing degrees of roughness. For example, the first washing member 220a may be formed from a coarser material than the second and third washing members 220b, 220c. This may allow each washing member to be used to clean a specific portion of a body. According to an embodiment of the invention, the washing members 220a-220c may be provided to wash and/or exfoliate a user's skin. The washing members 220a-220c may be configured to temporarily retain soap, body wash, and/or lotion to be applied to a user's body during use. While three washing members 220a-220c are shown in the figures, it should be appreciated that the washing device 200 may include more or less than three washing members 220.

According to an embodiment of the invention, the washing device 200 also includes one or more coupling elements 221a, 221b. The coupling elements 221a, 221b may be provided to couple two or more washing members 220a-220c. The size of the coupling elements 221 is shown exaggerated and in some embodiments, may not be visible during normal use without separating some of the material of the washing members 220a-220c. The coupling elements 221a, 221b may be coupled to the two or more washing members 220a-220c using known methods, such as mechanical fasteners, adhesives, etc.

According to an embodiment of the invention, the coupling elements 221a, 221b couple two or more washing members 220 along a longitudinal axis 250 of the washing device 200. Advantageously, the coupling elements 221a, 221b can couple the plurality of washing members 220 to form a single row of washing members. According to an embodiment of the invention, the coupling elements 221a, 221b are configured such that the longitudinal axis 250 as shown in FIG. 2 is not a fixed axis. In other words, the washing members 220 are free to move, bend, and/or rotate relative to one another in one or more directions. As a result, the position of the washing members 220a-220c relative to one another is not rigid, thereby allowing a user to more easily manipulate the washing device 200 during use. In embodiments where the coupling elements 221a, 221b are formed from an elastic material, the coupling elements 221a, 221b may also allow adjoining washing members 220a-220c to move apart from one another such that the space between the washing members 220a-220c is not fixed.

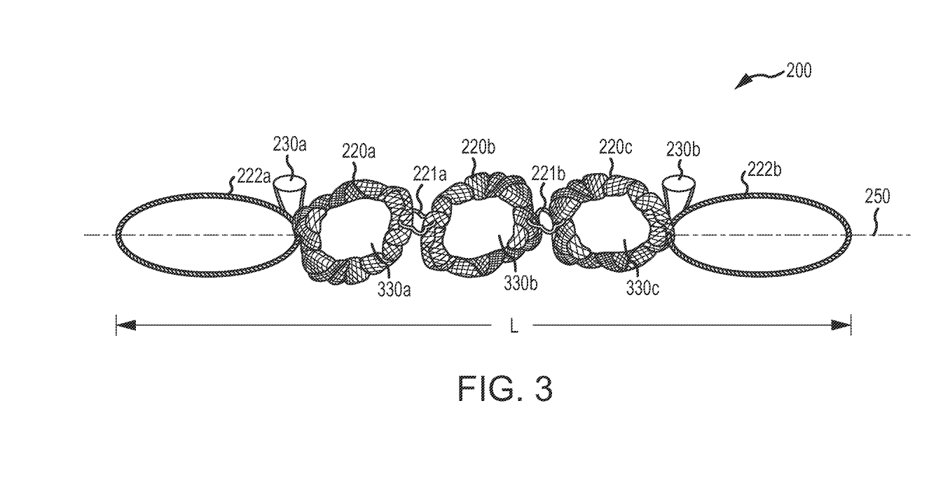

According to the embodiment shown in FIG. 3, the coupling elements 221a, 221b comprise ropes or cords that are inserted through an opening in a portion of each of the washing members 220a-220c with the ends tied together, thereby coupling the plurality of washing members 220a-220c. The opening 330 is shown exaggerated in order to illustrate how the washing members 220a-220c may be coupled. In actuality, the material used for the washing members 220a-220c may be bunched together and substantially surround the opening 330 thereby providing substantially uninterrupted cleaning around the entire surface of the washing members 220a-220c. Therefore, while the opening 330 is shown in each of the washing members 220a-220c, a user may not typically see the openings 330. Rather, despite the openings 330, the washing members 220a-220c may appear to comprise a substantially continuous outer surface. As can be appreciated, the use of ropes or cords as the coupling elements 221a, 221b allows adjoining washing members 220 to move relative to one another in multiple directions.

According to an embodiment of the invention, the coupling elements 221a, 221b may be partially elastic, thereby allowing the distance between adjoining washing members 220 to increase when a user applies a threshold level of tension to the washing device 200 along the longitudinal axis 250. In other embodiments, the coupling elements 221 may be relatively inelastic thereby maintaining a fixed distance between adjoining washing members 220. However, in this embodiment, the washing members 220 may be partially elastic in order to expand and increase the overall length, L, of the washing device 200. As shown, the length, L, extends parallel to the longitudinal axis 250 of the washing device 200.

According to an embodiment of the invention, one or more of the washing members 220 includes a handle 222. According to another embodiment of the invention, one or more of the coupling elements 221 includes a handle 222. According to some embodiments, the handles 222 may comprise integral components of the washing members 220 or the coupling elements 221, for example. According to an embodiment of the invention, two handles 222a, 222b are provided; however, the particular number of handles should not limit the scope of the present invention. In embodiments including handles 222a, 222b, the length, L, extends from an outer end of the first handle 222a to an outer end of the second handle 222b. The length, L, may increase by applying a threshold level of tension to one or both of the handles 222a, 222b. In the embodiment shown, a first washing member 220a includes a first handle 222a that extends from the first washing member 220a and a third washing member 220c includes a second handle 222b that extends from the third washing member 220c. It should be appreciated that in other embodiments, the first or second coupling elements 221a, 221b may include the first and second handles that extend from the coupling members 221a, 221b in a similar manner. The handles 222 may comprise a rigid material, such as plastic, or a substantially flexible material, such as rope, cord, fabric, nylon, etc. Further, the handles 222 may be elastic or relatively inelastic. The particular material used for the handles 222 is not important for purposes of the present invention and should in no way limit the scope of the present invention. The handles 222 may be provided to allow a user to easily grasp and manipulate the washing device 200 without requiring the user to directly grasp one of the washing members 220. Therefore, while the handles 222 are not required, the handles 222 allow a user to more easily wash difficult to reach areas as the handles 222 can extend beyond the washing members 220.

According to an embodiment of the invention, the washing device 200 also includes one or more attachment members 230. In the embodiment shown, the washing device 200 includes a first attachment member 230a and a second attachment member 230b. It should be appreciated that the washing device 200 may include a single attachment member or may include more than two attachment members. Therefore, the particular number of attachment members 230 should not limit the scope of the present invention. According to an embodiment of the invention, the attachment members 230a, 230b, may be attached to one of the washing members 220 or one of the coupling elements 221. The attachment members 230a, 230b may be coupled to any portion of the washing members 220 or coupling elements 221 including a portion of a handle 222 extending from the washing member 220 or coupling element 221. According to an embodiment of the invention, the washing device 200 includes two attachment members 230a, 230b, which are coupled at substantially opposite ends of the washing device 200. For example, in the embodiment shown in FIG. 2, the first attachment member 230a is located proximate the first washing member 220a while the second attachment member 230b is located proximate the third washing member 220c, which is separated from the first washing member 220b by the first and second coupling elements 221a, 221b and the second washing member 220b.

According to an embodiment of the invention, the attachment members 230a, 230b may comprise suction cups. Alternatively, the attachment members 230a, 230b may comprise hook and loop arrangements, magnetic members, adhesive members, etc. The attachment members 230a, 230b may be provided to attach the washing device 200 to a shower wall or door, for example. According to embodiments where the attachment members 230 do not comprise suction cups or other self-attaching members, a corresponding attachment member (not shown) may be provided on the shower wall or door according to known means, such as adhesives, suction cups, mechanical fasteners, etc. The corresponding attachment member can be adapted to receive and couple to an attachment member 230 of the washing device 200.

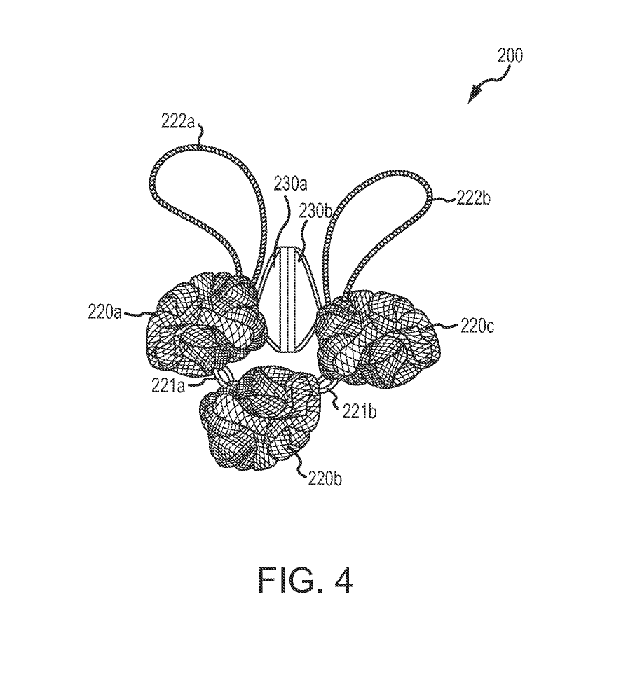

According to an embodiment of the invention, the attachment members 230a, 230b may also be provided to attach portions of the washing device 200 that are spaced apart (See FIG. 4 and the accompanying discussion).

FIG. 4 shows the washing device 200 according to another embodiment of the invention. In the embodiment shown in FIG. 4, the attachment members 230a, 230b are shown removably coupled to one another. In order to contact the attachment members 230a, 230b to one another, the washing members 220a-220c and coupling elements 221a, 221b are moved relative to one another to bring the attachment members 230a, 230b towards one another. According to one embodiment of the invention, the attachment members 230a, 230b may comprise suction cups as discussed above, which are pushed together and removably held using a suction force as is generally known in the art. Alternatively, if the attachment members 230a, 230b comprise other configurations such as a hook and loop arrangement, one of the attachment members 230a may comprise the hook portion and the other attachment member 230b may comprise the corresponding loop portion. Similar corresponding arrangements can be appreciated for magnetic or adhesive arrangements, for example.

With the first and second attachment members 230a, 230b coupled to one another, the single row washing device 200 that previously extended along the longitudinal axis 250 comprises a substantially ball or ring-shaped washing device. The configuration shown in FIG. 4 may be desired to wash portions of a user's body that are not as difficult to reach as a user's back, for example. When a user desires to once again wash a difficult to reach area or store the washing device 200, the user can provide a threshold force to the attachment members 230 to disengage the attachment members 230a, 230b from one another.

In use, a user can grasp one or both of the handles 222 and manipulate the washing device 200 in order to clean a portion of a body. The user may grasp one handle while an attachment member 230 is attached to a wall or other surface. The washing device 200 may be used in combination with water, soap, body wash, and/or lotion as is generally known. The washing members 220a-220c, the coupling elements 221a, 221b, or both may stretch or otherwise deform in order to extend the overall length, L, of the washing device 200. In addition or alternatively, the handles 222 may stretch due to tension provided by the user. After use, the user may attach the washing device 200 to a wall, a door, or other surface using one or both of the attachment members 230 to dry.

According to an embodiment of the invention, the user may also couple the two attachment members 230 as described above in order to form a ball or ring-shaped structure as shown in FIG. 4. With the attachment members 230 coupled to one another, a user may continue to wash a portion of a body without the danger or inconvenience of being entangled in loose hanging portions of the washing device 200. Further, with the attachment members 230 coupled to one another, a user may more easily handle the washing device 200. Therefore, the attachment members 230 not only provide a system for easy storage between uses, but also allow a user to conveniently wash difficult to reach areas and easy to reach areas with a single washing device 200.

The present invention as described above provides a washing device 200 that is suitable for multiple uses. The attachment members 230 allow the washing device 200 to convert from a relatively long, single row washing device 200 to a ball or ring-shaped washing device 200 that comprises a more compact configuration. Further, the attachment members 230 may be used to conveniently attach the washing device 200 to a wall or door of a shower between or during uses.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other cleaning devices, and not just to the embodiments described above and shown in the accompanying figures. Accordingly, the scope of the invention should be determined from the following claims.

We claim:

1. A washing device, comprising:
a plurality of washing members;
a coupling element coupling two or more of the plurality of washing members such that the plurality of washing members are movable relative to one another in one or more directions; and
a first attachment member coupled to one or more of the washing members or the coupling element.

2. The washing device of claim 1, wherein a washing member of the plurality of washing members or the coupling element includes a first handle.

3. The washing device of claim 2, wherein a washing member of the plurality of washing members or the coupling element further includes a second handle.

4. The washing device of claim 1, further comprising a second attachment member coupled to one or more of the washing members or the coupling element and spaced apart from the first attachment member.

5. The washing device of claim 4, wherein the second attachment member is adapted to be removably coupled to the first attachment member.

6. The washing device of claim 1, wherein the first attachment member comprises a suction cup.

7. A method of forming a washing device including a plurality of washing members, comprising steps of:
coupling two or more washing members of the plurality of washing members using a connecting element such that the two or more washing members are movable relative to one another in one or more directions; and
coupling a first attachment member to one or both of a washing member of the plurality of washing members and a connecting element.

8. The method of claim 7, further comprising a step of providing a washing member of the plurality of washing members or the coupling element with a first handle.

9. The method of claim 8, further comprising a step of providing a washing member of the plurality of washing members or the coupling element with a second handle.

10. The method of claim 7, further comprising a step of coupling a second attachment member to one or more of the washing members or the coupling element and spaced apart from the first attachment member.

11. The method of claim 10, wherein the second attachment member is adapted to be removably coupled to the first attachment member.

12. The method of claim 7, wherein the first attachment member comprises a suction cup.
